(19) United States
(12) Patent Application Publication
(10) Pub. No.: US 2006/0147796 A1
(43) Pub. Date: Jul. 6, 2006

(54) Positive battery electrodes and positive electrode fabrication methods

(75) Inventors: Tamaki Miura, Yamato-shi (JP); Junji Katamura, Yokohama-shi (JP); Mikio Kawai, Yokosuka-shi (JP)

Correspondence Address: SHUMAKER & SIEFFERT, P. A., 8425 SEASONS PARKWAY, SUITE 105, ST. PAUL, MN, 55125, US

(73) Assignee: Nissan Motor Co., Ltd., Yokohama-shi (JP)

(21) Appl. No.: 11/314,816

(22) Filed: Dec. 21, 2005

(30) Foreign Application Priority Data
Dec. 21, 2004 (JP) 2004-369719
Nov. 15, 2005 (JP) 2005-329748

(51) Int. Cl. H01M 4/02; H01M 4/62

(52) U.S. Cl. 429/209; 429/217; 429/232; 252/182.1

(57) ABSTRACT

The disclosure relates to positive electrodes for storage cells including a ground positive electrode active material and a conductivity enhancement additive, wherein the ground positive electrode active material exhibits a specific surface area of 5 m²/g or greater, a crystallite diameter of 70 nanometers or less, and a 50% cumulative particle diameter of 1 micrometer or less. The disclosure further relates to storage batteries including positive electrodes having ground positive electrode active material, and battery modules including multiple electrically connected batteries, each battery including one or more storage cells having a positive electrode including ground positive electrode active material. The disclosure also relates to methods of fabricating storage cells and batteries with positive electrodes having ground positive electrode active material. Storage cells according to some embodiments of the invention may have applications for motor vehicle batteries, particularly for electrically powered automobiles.

This application claims priority from Japanese Patent Application No. 2004-369719, filed Dec. 21, 2004 and Japanese Patent Application No. 2005-329748 filed Nov. 15, 2005, the entire contents of each are incorporated herein by reference.

### TECHNICAL FIELD

The invention relates to electric power storage batteries and techniques for fabricating batteries used in, for example, electrically powered motor vehicles.

### BACKGROUND

Recently, a decrease in the global emissions of carbon dioxide has been sought in order to protect the environment. In the automobile industry in particular, there is an active effort to decrease carbon dioxide emissions from internal combustion engines by introduction of electric vehicles (EV) and hybrid electric vehicles (HEV) powered by electric motors. This has led to recent progress in the development of lightweight and lower cost storage batteries for powering electric motors. In general, a storage battery includes one or more electrochemical cells, each cell including a negative electrode (i.e. an anode) electrically connected to a positive electrode (i.e. a cathode), wherein both electrodes are immersed in an electrolyte.

Although some storage batteries, for example lithium ion (i.e. LiON) batteries, can achieve high energy density and high output power density, the charge-discharge stability of such batteries may be poor. With particular regard to storage batteries for automobiles, higher electrical output power density has been sought, and improvements in the stability of battery charge-discharge cycling performance are desired. In particular, improvements in battery charge-discharge cycling stability, as reflected by the recovery of battery storage capacity to its pre-discharge level following high rate power consumption or deep electrical discharge potential operation, are actively sought.

### SUMMARY

In general, the present invention relates to storage batteries. For example, a secondary storage battery is described comprising one or more electrochemical cells. Each cell includes a negative electrode (i.e. an anode) electrically connected to a positive electrode (i.e. a cathode). Both electrodes are immersed in an electrolyte. In exemplary embodiments, the present invention relates to a positive electrode for a storage battery having a nonaqueous electrolyte, and methods of manufacturing positive electrodes for use in nonaqueous electrolytes. Nonaqueous electrochemical cell positive electrodes according to some embodiments of the present invention may be suitable for use as storage batteries for motor vehicles, particularly electrically powered motor vehicles, in that they may inhibit the degradation of battery capacity by large current discharge operation.

In one embodiment, a positive electrode for a secondary storage cell having a nonaqueous electrolyte comprises a ground positive electrode active material and a conductivity enhancement additive. In some embodiments, the positive electrode active material is selected to exhibit a specific surface area of about 5 m²/g or larger. In additional embodiments, the positive electrode active material is selected to exhibit a crystallite diameter of about 70 nanometers (nm) or less as determined by x-ray diffraction. In some additional embodiments, the positive electrode active material is selected to exhibit a 50% cumulative particle diameter of about 1 micrometer (μm) or less.

In some embodiments, the positive electrode further comprises an electrically conductive substrate having a surface overlayed by at least one layer comprising the positive electrode active material and the conductivity enhancement additive. In certain exemplary embodiments, the electrically conductive substrate comprises a metal foil. In additional embodiments, the positive electrode further comprises a polymeric binder material. In certain exemplary embodiments, the polymeric binder material comprises polyvinylidene fluoride.

In additional exemplary embodiments, the positive electrode active material contains at least one oxide selected from manganese composite oxides, nickel composite oxides, and cobalt composite oxides. In other exemplary embodiments, the conductivity enhancement additive contains at least one carbon material selected from graphite, non-crystalline carbon, amorphous carbon, and filamentous carbon.

In another embodiment, a secondary storage cell comprises a negative electrode, a positive electrode electrically connected to the negative electrode, and a nonaqueous electrolyte surrounding the positive and the negative electrode, wherein the positive electrode further comprises a positive electrode active material and a conductivity enhancement additive.

In an additional embodiment, a secondary storage cell comprises a negative electrode means, a positive electrode means electrically connected to the negative electrode means, and an electrolyte means in which the positive electrode means and the negative electrode means are both at least partially immersed. In some embodiments, the positive electrode means comprises at least a positive electrode active material and a conductivity enhancement additive. In certain exemplary embodiments, the positive electrode active material exhibits a specific surface area of about 5 m²/g or greater, a crystallite diameter determined by x-ray diffraction of about 70 nanometers or less, and a 50% cumulative particle diameter of about 1 micrometer or less.

In a further embodiment, a battery module comprises a plurality of secondary storage cells, each secondary storage cell electrically connected to the other secondary storage cells, wherein each secondary storage cell further comprises a negative electrode, a positive electrode electrically connected to the negative electrode, and a nonaqueous electrolyte surrounding the positive electrode and the negative electrode. In some embodiments, the positive electrode comprises a positive electrode active material and a conductivity enhancement additive. In certain exemplary embodiments, the electrically connected storage cells are electrically connected in series or in parallel.

In another embodiment, a method of fabricating a positive electrode for a battery having a nonaqueous electrolyte comprises grinding a positive electrode active material to form a ground positive electrode active material and adding a polymeric binder material, a conductivity enhancement additive and a polar organic solvent to the ground positive electrode active material to form a mixture. The mixture is kneaded for a time sufficient to form the slurry, and the slurry is applied to a surface of an electrically conductive substrate and dried to remove at least a portion of the polar organic solvent.

In other exemplary embodiments, the ground positive electrode active material is prepared using at least one of dry grinding or wet grinding. In certain embodiments, wet grinding comprises suspending the positive electrode active material in a liquid to form a suspension and applying a shear force to the suspension. In exemplary embodiments, the shear force is applied using at least one of a ball mill, a bead mill, a vibratory mill, a sand-mill, a homogenizer, a high shear disperser, an ultrasonic disperser, or a roll mill. In additional exemplary embodiments, kneading comprises at least one of planetary mixing, extrusion, 2-roll milling, or 3-roll milling. In certain exemplary embodiments, a time sufficient to form the slurry is between about 0.25 to about 8 hours.

In an additional embodiment, a method of fabricating a positive electrode for a battery having a nonaqueous electrolyte comprises dissolving a polymeric binder material in a polar organic solvent to form a polymeric binder solution, and adding a positive electrode active material and a conductivity enhancement additive to the polymeric binder solution to form a suspension. The method further comprises grinding the suspension for a time sufficient to form a slurry comprising ground positive electrode active material, applying the slurry to a surface of an electrically conductive substrate, and drying the slurry on the surface of the metal substrate to remove at least a portion of the polar organic solvent.

In certain embodiments, the electrically conductive substrate comprises a metal foil. In certain exemplary embodiments, grinding comprises applying a shear force to the suspension using at least one of a ball mill, a bead mill, a vibratory mill, a sand-mill, a homogenizer, a high shear disperser, an ultrasonic disperser, or a roll mill.

The details of one or more embodiments of the invention are set forth in the accompanying drawings and the description below. Other features, objects, and advantages of the invention will be apparent from the description and drawings, and from the claims.

### BRIEF DESCRIPTION OF DRAWINGS

FIG. 1 is a graph showing an example relationship between a crystallite diameter and a discharge capacity ratio according to exemplary positive electrodes of the present invention as compared to comparative example positive electrodes that are outside the scope of the present invention.

FIG. 2 is a graph showing the relationship between a specific surface area and a discharge capacity ratio according to exemplary positive electrodes of the present invention as compared to comparative example positive electrodes that are outside the scope of the present invention.

FIG. 3 is a photograph of a Scanning Electron Micrograph (SEM) of an exemplary positive battery electrode according to an embodiment of the present invention prepared according to Example 2.

FIG. 4 is a photograph of a SEM of a positive battery electrode outside the scope of the present invention prepared according to Comparative Example 1.

### DETAILED DESCRIPTION

Embodiments of the present invention provide a secondary storage cell including a positive electrode (i.e. a cathode) that is electrically connected to a negative electrode (i.e. an anode), and an electrolyte surrounding the positive and negative electrodes. The positive electrode for a nonaqueous electrolyte battery according to some embodiments of the present invention contains a ground positive electrode active material and a conductivity enhancement additive, and the ground positive electrode active material has a specific surface area of 5 m²/g or greater, a crystallite diameter with X-ray diffractometer of 70 nm or less, and a 50% cumulative particle diameter of 1 μm or less.

According to some embodiments, a reduction in battery storage capacity following large capacity discharge may be inhibited by controlling the specific surface area, the crystallite diameter, and the particle diameter of the positive electrode active material within predetermined limits. The reduction in storage capacity may be expressed as the battery discharge capacity ratio (also known as a battery capacity maintenance ratio), that is, the ratio of the storage capacity of the secondary storage cell or battery after deep electrical discharge, to the storage capacity immediately prior to discharge. Discharge capacity ratios may range between 0 and 1.0, with higher capacity ratios being preferred.

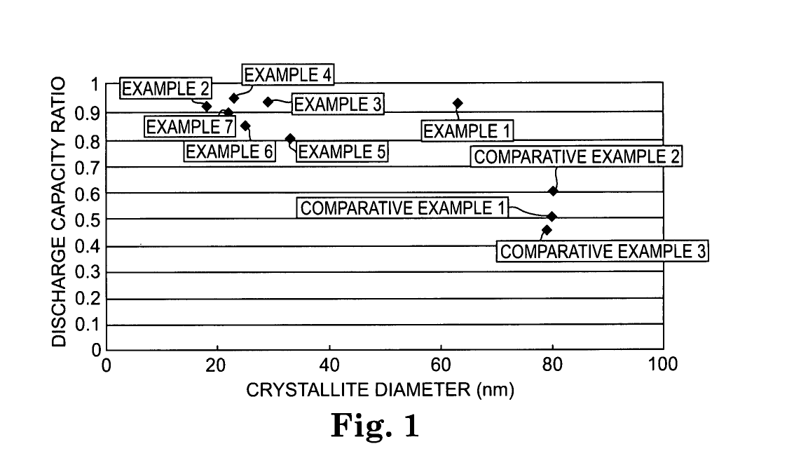

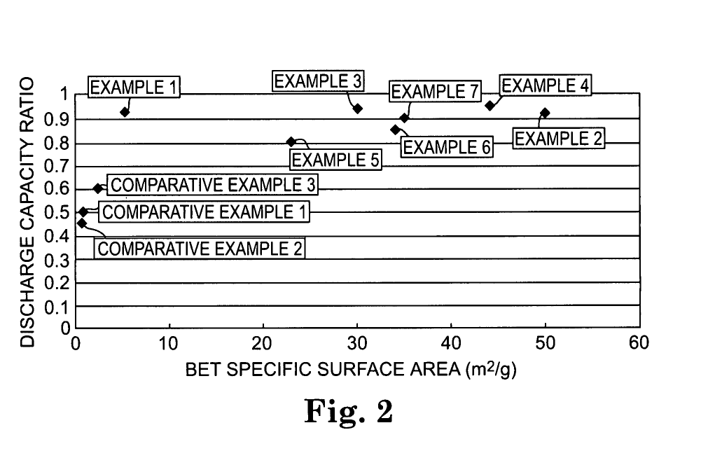

With reference to the drawings, FIG. 1 is a graph showing an example relationship between the crystallite diameter and the discharge capacity ratio for exemplary batteries fabricated according to the techniques described herein. FIG. 2 is a graph showing the relation between the specific surface area and the discharge capacity ratio of the batteries.

From FIG. 1, it can be seen that the discharge capacity ratio rapidly improves when the crystallite diameter becomes lower than about 70 nm. In addition, from FIG. 2, it is clear that the discharge capacity ratio significantly improves when the BET specific surface area exceeds about 5 m²/g. The specific surface area can be measured by means of the BET nitrogen absorption surface area measurement method, the crystallite diameter can be calculated from the half-value width of a diffraction peak provided by, for example, x-ray diffraction (XRD), and D50 can be measured by means of the laser diffraction light scattering method or the laser Doppler light scattering method.

The positive electrode active material may contain a manganese composite oxide, a nickel composite oxide, or a cobalt composite oxide, as well as combinations of the oxide materials with each other or with other materials. For example, lithium cobaltate, lithium nickelate, or lithium manganate may be used. Preferred raw materials for a positive electrode active material include, for example, 4V grade composite oxides, which are commercially available as electrode active materials for lithium ion batteries. For example, commercially available 4V grades exhibiting an electromotive force of around 4 V include lithium cobaltate, made by Nippon Chemical Industrial Co. and FMC Energy Systems Inc, lithium nickelate, made by Fuji Chemical Industry Co., Ltd. and Sumitomo Metal Industries, Ltd., and lithium manganate, made by Tosoh Corporation, Mitsui Mining & Smelting Co., Ltd., Nippon Denko Co., Ltd., and Nikki Chemical Co. These positive electrode active materials may be used alone, in combination with each other, or in combination with other materials without departing from the scope of the invention.

The conductivity enhancement additive may include, for example, carbonaceous materials, for example graphite, non-crystalline carbon, amorphous carbon, or filamentous carbon, as well as combinations of these materials with each other or with other electrically conductive materials.

In addition, the positive electrode for a nonaqueous electrolyte battery of the present invention may contain a binder material. Although the binder material is not particularly restricted, the binder preferably improves the shape and dimensional stability of the positive electrode, and the binder may preferably include a polymeric material. By using a polymeric material, exfoliation or scattering of the active positive electrode material and conductivity enhancement additive may be inhibited during manufacturing of the positive electrode. Suitable polymeric binder materials include, for example, polyvinylidene fluoride (PVDF), a styrene-butadiene rubber, carboxymethylcellulose and polytetrafluoro-ethylene. PVDF may be preferably used as the binder material.

One particular example of a nonaqueous battery is a lithium ion (LiON) battery. The negative electrode (i.e. anode) active materials useful in fabricating a lithium ion battery in accordance with the embodiments described herein are not particularly limited, provided that they occlude and desorb lithium ions. Typically, a carbon-based material such as graphite and a non-crystalline carbon or lithium metal may be used to fabricate negative electrodes.

In addition, the electrolyte that may be used within certain embodiments of LiON batteries described herein is not particularly limited provided it exhibits properties of an electrolytic solution comprising a solvent and a supporting salt. The electrolyte solvent typically includes nonaqueous solvents which are polar organic liquids, such as carbonates, ethers, and ketones, preferably, combined as a solution with at least one high dielectric constant solvent chosen from ethylene carbonate (EC), a propylene carbonate (PC), and y-butyl lactone (GBL), and the like, and at least one kind of low viscosity solvent chosen from among a diethyl carbonate (DEC), a dimethyl carbonate (DMC), and an ethyl methyl carbonate (EMC) may be used. At least one salt selected from LiClO4, LiPF6, LiBF4, and LiCF3SO3, and the like, may preferably be used as the supporting salt.

The nonaqueous electrolyte secondary batteries of some embodiments of the present invention include a negative electrode (i.e. an anode or negative electrode means), a positive electrode (i.e. a cathode or positive electrode means) electrically connected to the negative electrode, and a nonaqueous electrolyte (i.e. an electrolyte means) surrounding the negative and positive electrodes, wherein the positive electrode further comprises a positive electrode active material and a conductivity enhancement additive. The nonaqueous electrolyte battery, including a positive electrode having a ground positive electrode active material, may exhibit less of a reduction in battery capacity following a large current discharge.

Next, the fabrication methods of positive electrodes for a nonaqueous electrolyte battery of the present invention will be described in detail. One exemplary fabrication method of the positive electrode for a nonaqueous electrolyte battery according to some embodiments of the present invention includes wet or dry grinding of the positive electrode active material, adding the conductivity enhancement additive, adding a polar organic solvent, making a slurry by kneading, and then applying the resulting slurry to a surface of an electrically conductive substrate, such as a metal foil, to dry.

The desired ground positive electrode active material for a positive electrode of a nonaqueous electrolyte battery may be obtained using a wet or dry grinding process. Since the electrode is fabricated after wet or dry grinding the positive electrode active material, the positive electrode may be prepared using positive electrode active material exhibiting a specific surface area larger than 5 m²/g, a crystallite diameter with X-ray diffractometer smaller than 70 nm, and 50% cumulative particle diameter smaller than 1 μm.

In some embodiments, wet grinding, including suspending the positive electrode active material in a liquid to form a suspension and applying a shear force to the suspension, is used. In certain embodiments, the shear force is applied using at least one of a ball mill, a bead mill, a vibratory mill, a sand-mill, a homogenizer, a high shear disperser, an ultrasonic disperser, or a roll mill. In additional embodiments, the shear force is applied using a kneading process. In certain preferred embodiments, kneading includes at least one of planetary mixing, extrusion, 2-roll milling, or 3-roll milling. In certain embodiments, a time sufficient to form a slurry of ground positive electrode active material exhibiting a specific surface area larger than 5 m²/g, a crystallite diameter by X-ray diffraction smaller than 70 nm, and a 50% cumulative particle diameter smaller than 1 μm by wet grinding is between about 0.25 to about 8 hours.

In some embodiments, a solution can be made to introduce a polymeric binder material in which the polymeric binder material is dissolved into a polar organic solvent, a positive electrode active material and conductivity enhancement additive are added into the resulting solution, a slurry is made by wet grinding, and then the resulting slurry is applied on metal foil and dried.

In addition, a fabrication process as described above is preferable from a view point of uniformity in obtaining a homogeneous dispersion of the electrode composition and in avoiding handling problems, such as dust collection and dust explosion potential, by eliminating the use of atomization processes for introducing a polymeric binder material, as is currently practiced in the art.

### EXAMPLES

The present invention is explained in detail below on the basis of the Examples and the Comparative Examples, though it is understood that the scope of the invention is not limited to these embodiments. In each example, the specific surface area of the positive electrode active material, the crystallite diameter, and the 50% cumulative particle diameter are measured and calculated in the following manner.

The specific surface area was measured by means of the single-point BET nitrogen absorption method, using a model SA-9601 continuous flow surface area meter manufactured by Horiba Instruments (Santa Barbara, Calif.). Particle size measurements were carried out to determine the 50% cumulative particle diameter by means of laser doppler light scattering (i.e. dynamic light scattering) using the MICROTRAC UPA particle size analyzer manufactured by Leeds and Northrup Co. (North Wales, Pa.). N-methyl-2-pyrrolidone (NMP) was used as the dispersion medium for all of the particle size measurements. The crystallite diameter was measured using x-ray diffraction at 2θ=10° to 80° and a voltage of 40 kV, a current of 300 mA, and using a MXP18VAHF CuKα x-ray source manufactured by MacScience Co., Ltd. (Yokohama, Japan).
D=K*λ/(B*cos θ) (1)
In formula (1), D is the crystallite diameter, K is the Scherrer constant, λ is the incidence X-rays wavelength, B is the half-value width, and θ is the X-rays incidence angle.

### Example 1

A lithium manganese composite oxide (LiMn₂O₄) having spinel structure (Tosoh Corporation) was used as a starting material of the positive electrode active material. This starting material was dry ground and classified to obtain the ground positive electrode active material. The specific surface area, the crystallite diameter, and the 50% cumulative particle diameter of the resulting ground positive electrode active material were measured and calculated in the above manner. The results obtained are summarized in Table 1.

Eighty parts by mass of the resulting ground positive electrode active material were kneaded with 10 parts by mass carbon black (Denki Kagaku Kogyo K.K., HS1100), which is a conductivity enhancement additive, and 10 parts by mass of PVDF (Kureha Chemical Industry Co., Ltd., #1300), which is a polymeric binder material, with sufficient N-methyl-2-pyrrolidone (NMP), which is a solvent, to make a slurry. The resulting slurry was applied on aluminum foil at a thickness of around 15 μm, and dried at 130° C. for 10 minutes to obtain the positive electrode for a nonaqueous electrolyte battery according to this example.

### Example 2

The same starting material as Example 1 was used. Using a bead mill type wet grinding machine, this starting material was put into a chamber filled with 70% φ 0.5 mm zirconia beads, rotated for two hours with NMP solvent, and wet ground to obtain the ground positive electrode active material. Ten parts by mass of PVDF were added gradually to the ground positive electrode active material having 80 parts by mass of NMP solvent. Then, 10 parts by mass of carbon black were added gradually, and the solvent amount was adjusted to make a slurry. After this process, the specific surface area, the crystallite diameter, and the 50% cumulative particle diameter of the ground positive electrode active material obtained in the slurry were measured and calculated in the above manner. The results obtained are summarized in Table 1.

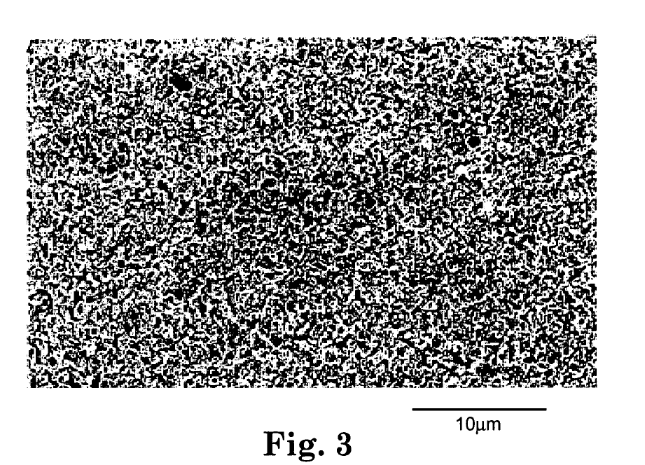

Using the resulting slurry and the application and drying process described in Example 1, a positive electrode for a nonaqueous electrolyte battery according to another embodiment of the invention was obtained. FIG. 3 is a scanning electron microscope (SEM) photograph of the positive electrode for a nonaqueous electrolyte battery of this embodiment. While not wishing to be bound by any particular theory, it is believed that positive electrode structures as shown in FIG. 3, in which the conductivity enhancement additive and the polymeric binder material are uniformly and densely distributed throughout the polymeric binder material, may exhibit less reduction in battery capacity at the time of a large current discharge as reflected by a higher discharge capacity ratio.

### Example 3

The same starting material as Example 1 was used. Using a bead mill type wet grinding machine, this starting material was put into a chamber filled with 70% φ 0.5 mm zirconia beads, rotated for one hour with NMP solvent, and wet ground to obtain the ground positive electrode active material. Ten parts by mass of PVDF were added gradually into the ground positive electrode active material having 80 parts by mass of NMP solvent. Then, 10 parts by mass of carbon black were added gradually, and the solvent amount was adjusted to make a slurry. After this process, the specific surface area, the crystallite diameter, and the 50% cumulative particle diameter of the ground positive electrode active material obtained in the slurry were measured and calculated in the above manner. The results obtained are summarized in Table 1. Using the resulting slurry and the application and drying process described in Example 1, a positive electrode for a nonaqueous electrolyte battery according to another embodiment of the invention was obtained.

### Example 4

The same starting material as Example 1 was used. Using a bead mill type wet grinding machine, this starting material was put into a chamber filled with 70% φ 0.5 mm zirconia beads, rotated for 0.5 hours with NMP solvent, and wet ground to obtain the ground positive electrode active material. Ten parts by mass of PVDF were added gradually into the ground positive electrode active material having 80 parts by mass of NMP solvent. Then, 10 parts by mass of carbon black were added gradually, and the solvent amount was adjusted to make a slurry. After this process, the specific surface area, the crystallite diameter, and the 50% cumulative particle diameter of the ground positive electrode active material obtained in the slurry were measured and calculated in the above manner. The results obtained are summarized in Table 1. Using the resulting slurry and the application and drying process described in Example 1, a positive electrode for a nonaqueous electrolyte battery according to another embodiment of the invention was obtained.

### Example 5

Lithium manganese composite oxide with an Al-substituted spinel structure (formula: Li_{1.1}Mn_{1.8}A_{10.1}O₄, manufactured by Nikki Chemical Co., Ltd.) was used as the starting material. Using a bead mill type wet grinding machine, this starting material was put into a chamber filled with 70% φ 0.5 mm zirconia beads, rotated for 0.5 hours with NMP solvent, and wet ground to obtain the ground positive electrode active material. Ten parts by mass of PVDF were added gradually to the ground positive electrode active material having 80 parts by mass of NMP solvent. Then, 10 parts by mass of carbon black were added gradually, and the solvent amount was adjusted to make a slurry. After this process, the specific surface area, the crystallite diameter, and the 50% cumulative particle diameter of the ground positive electrode active material obtained in the slurry were measured and calculated in the above manner. The results obtained are summarized in Table 1. Using the resulting slurry and the application and drying process described in Example 1, a positive electrode for a nonaqueous electrolyte battery according to another embodiment of the invention was obtained.

### Example 6

The same starting material as Example 5 was used. Using a bead mill type wet grinding machine, this starting material was put into a chamber filled with 70% φ 0.5 mm zirconia beads, rotated for one hour with NMP solvent, and wet ground to obtain the ground positive electrode active material. Ten parts by mass of PVDF were added gradually to the ground positive electrode active material having 80 parts by mass of NMP solvent. Then, 10 parts by mass of carbon black were added gradually, and the solvent amount was adjusted to make a slurry. After this process, the specific surface area, the crystallite diameter, and the 50% cumulative particle diameter of the ground positive electrode active material in the slurry were measured and calculated in the above manner. The results obtained are summarized in Table 1. Using the resulting slurry and the application and drying process described in Example 1, a positive electrode for a nonaqueous electrolyte battery according to another embodiment of the invention was obtained.

### Example 7

The same starting material as Example 5 was used. Using a bead mill type wet grinding machine, this starting material was put into a chamber filled with 70% φ 0.5 mm zirconia beads, rotated for 1.25 hours with NMP solvent, and wet ground to obtain the ground positive electrode active material. Ten parts by mass of PVDF were added gradually into the positive electrode active material having 80 parts by mass of NMP solvent. Then, 10 parts by mass of carbon black were added gradually, and the solvent amount was adjusted to make a slurry. After this process, the specific surface area, the crystallite diameter, and the 50% cumulative particle diameter of the ground positive electrode active material in the slurry were measured and calculated in the above manner. The results obtained are summarized in Table 1. Using the resulting slurry and the application and drying process described in Example 1, a positive electrode for a nonaqueous electrolyte battery according to another embodiment of the invention was obtained.

### Comparative Example 1

The same starting material as Example 1 was used and classified to obtain an unground positive electrode active material. The specific surface area, the crystallite diameter, and the 50% cumulative particle diameter of the resulting unground positive electrode active material were measured and calculated in the above manner. The results obtained are summarized in Table 1. Eighty parts by mass of the resulting unground positive electrode active material were kneaded with 10 parts by mass of carbon black and 10 parts by mass of PVDF to make a slurry in NMP. Using the resulting slurry and the application and drying process described in Example 1, a positive electrode for a nonaqueous electrolyte battery containing an unground positive electrode active material according to a comparative example was obtained.

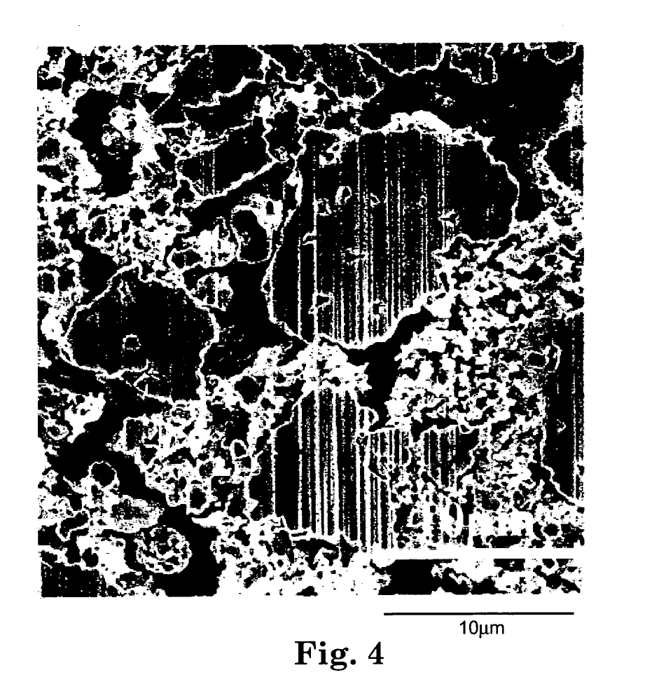

FIG. 4 is an SEM photograph of the positive electrode for a nonaqueous electrolyte battery of this comparative example. While not wishing to be bound by any particular theory, it is believed that positive electrode structures as shown in FIG. 4, in which the conductivity enhancement additive and the polymeric binder material are stuck to the surface of relatively large positive electrode active material portions, may exhibit a reduction in battery capacity at the time of a large current discharge.

### Comparative Example 2

The same starting material as Example 5 was used and classified to obtain an unground positive electrode active material. The specific surface area, the crystallite diameter, and the 50% cumulative particle diameter of the resulting unground positive electrode active material were measured and calculated in the above manner. The results obtained are summarized in Table 1. Eighty parts by mass of the resulting unground positive electrode active material were kneaded with 10 parts by mass of carbon black and 10 parts by mass of PVDF to make a slurry in NMP. Using the resulting slurry and the application and drying process described in Example 1, a positive electrode for a nonaqueous electrolyte battery containing an unground positive electrode active material according to a comparative example was obtained.

### Comparative Example 3

The same starting material as Example 5 was used and dry ground to obtain a coarsely-ground positive electrode active material. The specific surface area, the crystallite diameter, and the 50% cumulative particle diameter of the resulting coarsely-ground positive electrode active material were measured and calculated in the above manner. The results obtained are summarized in Table 1. Eighty parts by mass of the resulting coarsely-ground positive electrode active material were kneaded with 10 parts by mass of carbon black and 10 parts by mass of PVDF to make a slurry in NMP. Using the resulting slurry and the application and drying process described in Example 1, a positive electrode for a nonaqueous electrolyte battery containing a coarsely-ground positive electrode active material according to a comparative example was obtained.

Positive Battery Electrode Performance Evaluation

Nonaqueous batteries were prepared using the positive battery electrodes fabricated in Examples 1-7 and Comparative Examples 1-3. Charging and discharging tests were conducted using a tri-polar cell using metal lithium as a counter electrode and quartz filter paper as a reference electrode. An electrolytic solution was used in which lithium phosphate hexafluoride (LiPF₆) with a density of 1 mol/L, was dissolved into a solvent in which ethylene carbonate (EC), propylene carbonate (PC), and diethyl carbonate (DEC) are mixed at a ratio of EC/PC/DEC of 2/2/6 by volume.

The battery was charged to full capacity using a charging current of 500 μA. Battery capacity was then determined at a time corresponding to a 20 mA discharge and a time corresponding to a 100 μA discharge, thereby permitting calculation of the discharge capacity ratio as the ratio of the capacity at 20 mA discharge to the capacity at 100 μA discharge. The results obtained are summarized in Table 1.

Referring to Table 1 and FIGS. 1-2, it can be seen that the discharge capacity ratios corresponding to a large current discharge for Examples 1-7, which are within the scope of the present invention, are substantially higher than the discharge capacity ratios of Comparative Examples 1-3, which are outside the scope of the present invention.

TABLE 1

| | | 50% | BET | | | Positive |
|---|---|---|---|---|---|---|
| | Crystallite | Cumulative | Specific | Discharge | | Electrode |
| | Diameter | Particle Diameter | Surface Area | Capacity | Treatment | Active |
| | (nm) | (μm) | (m²/g) | Ratio | Method | Material |
| Example 1 | 63 | 0.92 | 5.3 | 0.93 | Dry Ground | Manganese |
| | | | | | | Oxide Spinel |
| Example 2 | 18 | 0.38 | 50 | 0.92 | Wet Milling | Manganese |
| | | | | | | Oxide Spinel |
| Example 3 | 29 | 0.35 | 30 | 0.94 | Wet Milling | Manganese |
| | | | | | | Oxide Spinel |
| Example 4 | 23 | 0.33 | 44 | 0.95 | Wet Milling | Manganese |
| | | | | | | Oxide Spinel |
| Example 5 | 33 | 0.38 | 23 | 0.80 | Wet Milling | Aluminum- |
| | | | | | | substituted |
| | | | | | | Manganese |
| | | | | | | Oxide Spinel |
| Example 6 | 25 | 0.37 | 34 | 0.85 | Wet Milling | Aluminum- |
| | | | | | | substituted |
| | | | | | | Manganese |
| | | | | | | Oxide Spinel |
| Example 7 | 22 | 0.35 | 35 | 0.90 | Wet Milling | Aluminum- |
| | | | | | | substituted |
| | | | | | | Manganese |
| | | | | | | Oxide Spinel |
| Comparative | 80 | 11.2 | 0.83 | 0.50 | Ingredient | Manganese |
| Example 1 | | | | | Classification | Oxide Spinel |
| Comparative | 79 | 13.7 | 0.7 | 0.45 | Ingredient | Aluminum- |
| Example 2 | | | | | Classification | substituted |
| | | | | | | Manganese |
| | | | | | | Oxide Spinel |
| Comparative | 80 | 2.6 | 2.4 | 0.60 | Dry Ground | Aluminum- |
| Example 3 | | | | | | substituted |
| | | | | | | Manganese |
| | | | | | | Oxide Spinel |

Various embodiments of the invention have been described. These and other embodiments are the scope of the following claims.

1. A positive electrode for a secondary storage cell comprising:
a positive electrode active material; and
a conductivity enhancement additive;
wherein the positive electrode active material exhibits a specific surface area of about 5 m²/g or greater, a crystallite diameter of about 70 nanometers or less, and a 50% cumulative particle diameter of about 1 micrometer or less.

2. The positive electrode of claim 1, further comprising a polymeric binder material.

3. The positive electrode of claim 2, wherein the polymeric binder material comprises polyvinylidene fluoride.

4. The positive electrode of claim 1, wherein the positive electrode active material comprises one or more composite oxide selected from the group consisting of manganese composite oxides, nickel composite oxides, and cobalt composite oxides.

5. The positive electrode of claim 1, wherein the conductivity enhancement additive comprises one or more carbonaceous materials chosen from the group consisting of graphite, non-crystalline carbon, amorphous carbon, and filamentous carbon.

6. A secondary storage cell, comprising:
a negative electrode;
a positive electrode electrically connected to the negative electrode; and
an electrolyte surrounding the positive electrode and the negative electrode;
wherein the positive electrode comprises a positive electrode active material and a conductivity enhancement additive; and
wherein the positive electrode active material exhibits a specific surface area of 5 m²/g or greater, a crystallite diameter determined by x-ray diffraction of 70 nanometers or less, and a 50% cumulative particle diameter of 1 micrometer or less.

7. The secondary storage cell of claim 6 further comprising a polymeric binder material.

8. The secondary storage cell of claim 7, wherein the polymeric binder material comprises polyvinylidene fluoride.

9. The secondary storage cell of claim 6, wherein the positive electrode active material comprises one or more composite oxide selected from the group consisting of manganese composite oxides, nickel composite oxides, and cobalt composite oxides.

10. The secondary storage cell of claim 6, wherein the conductivity enhancement additive comprises one or more carbonaceous materials chosen from the group consisting of graphite, non-crystalline carbon, amorphous carbon, and filamentous carbon.

11. A secondary storage cell, comprising:
a negative electrode means;
a positive electrode means electrically connected to the negative electrode means; and
an electrolyte means in which the positive electrode means and the negative electrode means are both at least partially immersed;
wherein the positive electrode means comprises at least a positive electrode active material and a conductivity enhancement additive; and
wherein the positive electrode active material exhibits a specific surface area of 5 m²/g or greater, a crystallite diameter determined by x-ray diffraction of 70 nanometers or less, and a 50% cumulative particle diameter of 1 micrometer or less.

12. A method of fabricating a positive electrode for a nonaqueous electrolyte battery, comprising:
grinding a positive electrode active material to form a ground positive electrode active material;
adding a polymeric binder material, a conductivity enhancement additive and a polar organic solvent to the ground positive electrode active material to form a mixture;
kneading the mixture for a time to form a slurry;
applying the slurry to a surface of an electrically conductive substrate; and
drying the slurry on the surface of the metal substrate.

13. The method of claim 12, wherein the ground positive electrode active material exhibits a specific surface area of 5 m²/g or greater, a crystallite diameter determined by x-ray diffraction of 70 nanometers or less, and a 50% cumulative particle diameter of 1 micrometer or less.

14. The method of claim 12, wherein the electrically conductive substrate comprises a metal foil.

15. The method of claim 12, wherein grinding comprises at least one of dry grinding or wet grinding.

16. The method of claim 15, wherein wet grinding comprises suspending the positive electrode active material in a liquid to form a suspension and applying a shear force to the suspension.

17. The method of claim 16, wherein the shear force is applied using at least one of a ball mill, a bead mill, a vibratory mill, a sand-mill, a homogenizer, a high shear disperser, an ultrasonic disperser, or a roll mill.

18. The method of claim 12, wherein kneading comprises at least one of planetary mixing, extrusion, 2-roll milling, or 3-roll milling.

19. The method of claim 12, wherein the time is between about 0.25 to about 8 hours.

20. A method of fabricating a positive electrode for a nonaqueous electrolyte battery, comprising:
dissolving a polymeric binder material in a polar organic solvent to form a polymeric binder solution;
adding a positive electrode active material and a conductivity enhancement additive to the polymeric binder solution to form a suspension;
grinding the suspension for a time to form a slurry comprising ground positive electrode active material;
applying the slurry to a surface of an electrically conductive substrate; and
drying the slurry on the surface of the metal substrate to remove at least a portion of the polar organic solvent.

21. The method of claim 20, wherein the ground positive electrode active material exhibits a specific surface area of 5 m²/g or greater, a crystallite diameter determined by x-ray diffraction of 70 nanometers or less, and a 50% cumulative particle diameter of 1 micrometer or less.

22. The method of claim 20, wherein the electrically conductive substrate comprises a metal foil.

23. The method of claim 20, wherein grinding comprises applying a shear force to the suspension using at least one of a ball mill, a vibratory mill, a sand-mill, a homogenizer, a high shear disperser, an ultrasonic disperser, or a roll mill.
